(19) United States
(12) Patent Application Publication
(10) Pub. No.: US 2008/0059443 A1
(43) Pub. Date: Mar. 6, 2008

(54) METHOD AND SYSTEM FOR THE EXTRACTION OF A DATA TABLE FROM A DATA BASE, CORRESPONDING COMPUTER PROGRAM PRODUCT

(75) Inventors: Aurelie Le Cam, Lannion (FR); Raphael Feraud, Perros Guirec (FR); Marc Boulle, Tregastel (FR)

Correspondence Address: WESTMAN CHAMPLIN & KELLY, P.A., SUITE 1400, 900 SECOND AVENUE SOUTH, MINNEAPOLIS, MN, 55402-3319, US

(73) Assignee: France Telecom, Paris (FR)

(21) Appl. No.: 11/848,762

(22) Filed: Aug. 31, 2007

(30) Foreign Application Priority Data
Sep. 1, 2006 (FR) 06/07695

(51) Int. Cl. G06F 7/10

(52) U.S. Cl. 707/4; 707/E17.008

(57) ABSTRACT

A method is provided for the extraction of a data table from a database. The data table includes instances in rows and columns, respectively, and includes indicators characterizing the instances in columns and rows, respectively. The method includes the following steps: a) obtaining an initial specification of the study; b) from the initial specification, building a data table extraction dictionary, which enables specifying instants concerned by the study in the database and enables specifying an extraction formula, a recoding and a role for each of the indicators concerned by the study; and c) carrying out an initial extraction of a data table, in applying the extraction dictionary to the database.

### 1. FIELD OF THE DISCLOSURE

The field of the disclosure is that of decision-related information technology, i.e. business intelligence, and more specifically that of data-mining.

Data-mining can be used to convert the different data sources of a company (customer-related, traffic-related, textual, multimedia and other data) into exploitable knowledge. In other words, data-mining covers all the techniques by which data can be enriched and exploited in order to achieve an operational goal.

More specifically, the disclosure relates to a technique for the extraction of a data table from a source database.

1.1 Terminology

Data Table: a table whose rows comprise the instances covered by the study and whose columns comprise the indicators that characterize these instances.

“Data warehouse” (DWH): a database for grouping, consolidating and historicizing the data in order to make it available for a set of applications.

Data mart: database oriented towards a particular application.

ETL (“Extraction Transformation and Loading”): tool used to carry out extraction and conversion (or transformation) from one data source to another data source.

Instance: row in a data table or table. An instance is understood to mean for example a customer, a product, a communication, a transaction, an IP address etc or more generally any element that can be processed as an independent unit or a member of a particular category, concerning which data can be stored.

Indicator: variable computed from one or more attributes of a relational database i.e. from detailed data of this relational database. An attribute is sometimes also called a field.

Score: result of a model aimed at forecasting, estimating a characteristic of an instance (for example appetence)

1.2 Problems Related to Data Analysis

Statistics, whether descriptive or predictive, are used to analyze data in order to extract knowledge therefrom, for example knowledge on:

the genes in which a genetic illness is encoded;
the IP sessions corresponding to intrusion into a local area network;
images that contain a sunset;
customers having high appetence for a product.

The use of statistical methods requires that data be presented in the form of a data table with rows containing the instances and columns containing the indicators that characterize these instances. This mode of storage is inefficient. This is why to optimize storage when the volumetry is high, the data is stored in relational databases and this is done whatever the phenomenon being studied: genes, bank card transactions, IP sessions, information on customers etc.

The analyst's first task is to extract the data table corresponding to the problem dealt with. In the following part, we shall provide a detailed description of the tool available to the analysts to extract a data table.

### 2. BACKGROUND OF THE DISCLOSURE

2.1 State of the Art

2.1.1 Data Storage

Referring to FIG. 1, we now present a classic decision information system.

In the decision information system of a large firm, the data is stored in a data warehouse 2. This relational database models all the interactions of the firm with its environment: customers, suppliers, internal organization etc.

The data models associated with the data warehouses are very complex. They commonly contain several hundreds of tables. Because of the number of tables, the execution of a query enabling extraction of a data table from such a database may be costly in terms of time and computer resources.

This is why, in the decision information system, it is common practice to add a storage stage: the data marts 4₁ to 4₅. A data mart is a relational database in which the data is prepared for particular use. Through the use of star pattern data models, the computation of indicators is optimized for each branch of activity of the firm, for example, product analysis, management, customer analysis, optimization of the telecommunications network etc.

To analyze the data, a final storage level is needed: the data tables 61 to 6₇. The bases of studies are data tables dedicated to the performance of a study. For example, customer loyalty development, appetence for a product, fraud detection, detection of malfunction in a network etc. The instances and the indicators of the data table are different for each of the studies. The database must be built by the analyst. This is not a trivial step as the number of potential representations of data in a data table is huge.

Thus, a classic decision will information system comprises three stages of storage:
the data warehouse 2;
the data marts 4₁ to 4₅; and
the data tables 6₁ to 6₇.

Again, as already shown in FIG. 1, the architecture of a classic decision information system furthermore comprises:
a stage (referenced 1) of processing for data feed to the data warehouse;
a stage (referenced 3) of processing for input/output interfacing between the data warehouse and the data marts;
a stage (referenced 5) of processing for input/output interfacing between the data marts and the data tables; and
a stage (referenced 7) comprising data mining tools implementing the branch applications.
   2.1.2 Access to Data

To extract a data table, analysts have a query language at their disposal: SQL (structured query language). This language is used especially to compute indicators and extract data tables. Furthermore, certain data analysis software programs such as SAS (registered mark) or SPSS (registered mark), have graphic tools to facilitate the programming of the queries.

2.1.3 Selection of Data

Most data analysis software programs (Kxen (registered mark), SAS (registered mark etc) have functions for the selection, from a data table, of a subset of relevant indicators relevant to a given problem.

Similarly, these software programs are used to select instances by sampling or by filtering.

2.2 Limitations

To extract a data table, the analyst has an optimized storage mode, the data mart, a query language mainly SQL and indicator selection tools at his disposal.

The main limitation arises out of the fact that the process of extraction and selection of the data tables is a manual process. The analyst must produce a program with which to extract a data table from one or more data marts, then analyze this data table. This operation is repeated as many times as necessary for the selection of a set of indicators relevant to the study considered. Now, the number of potential indicators is so great that it is impossible for the analyst to test them all by a process of this kind.

### 3. SUMMARY

In one particular aspect of the disclosure, a method is proposed for the extraction of a data table from a database, said data table comprising instances in rows and columns respectively and comprising indicators characterizing said instances in columns and rows respectively, said method comprising the following steps:
a) obtaining an initial specification of a study;
b) from said initial specification, building a data table extraction dictionary enabling the following:
   specifying instances concerned by the study in the database;
   specifying an extraction formula, a recoding and a role for each of the indicators concerned by the study; and
c) carrying out an initial extraction of a data table, in applying said extraction dictionary to said database.

An exemplary general principle of this particular aspect of the disclosure therefore includes of a technical solution of automatizing the process of extraction of a data table, based on the construction and use of an extraction dictionary generically linked to the source database. This automation of the extraction process includes driving the information exchanges between the source database, the query language and the data selection module.

This makes it possible to resolve a technical problem, namely that of simplifying and reducing the cost of the operations for extracting a data table, while at the same time increasing the number of indicators evaluated at a reasonable processing cost.

It is important to note that this particular aspect of the disclosure is aimed at modifying not the branch applications implemented with data mining tools (the stage referenced 7 in FIG. 1) but the processing for input/output interfacing between a data warehouse and a data table (stages reference 3 and 5 in FIG. 1). In other words, the solution proposed to perform the extraction of the data table is a technical solution (building of an extraction dictionary and application of this dictionary to a source database) to a technical problem (see here above), this solution being possibly implemented whatever the nature, technical or non-technical, of the branch application for which the data table is built.

Advantageously, said data table extraction dictionary comprises:
a data folder selection dictionary to specify the instances concerned by the study in the database; and
a data folder indicators calculation dictionary to specify the formula of extraction, the recoding and the role of each of the indicators.

Advantageously, said step for the extraction of the data table comprises the following steps:
application of said data folder selection dictionary to said database, in order to pertain a filtered database; and
application of said data folder indicators calculation dictionary to said filtered database in order to obtain said data table.

Advantageously, said data folder selection dictionary takes the form of a data table comprising conditions in rows and columns respectively and characteristics characterizing said conditions in columns and rows respectively. Each condition may correspond to an inclusion or an exclusion. Each row of the data folder selection dictionary is linked to the previous one by a logic AND operator.

Advantageously, said data folder indicators calculation dictionary comprises:
a data folder query dictionary used to specify the formula of extraction of each of the indicators; and
a data table preparation dictionary used to specify the recoding and role of each of the indicators.

Advantageously, said data folder query dictionary takes the form of a data table comprising elementary queries in rows and columns respectively and comprising characteristics characterizing said elementary queries in columns and rows respectively. Furthermore, at each initial or supplementary step of extraction of a data table:
each elementary query enables the extraction from said database of an elementary data table; and
the elementary data tables are concatenated by columns and rows respectively in order to obtain said data table.

Advantageously, said data table preparation dictionary takes the form of a data table comprising said indicators in rows and columns respectively and characteristics characterizing said elementary indicators in columns and rows respectively.

Advantageously, the initial specification of the study specifies:
no target indicator or a target indicator;
a population concerned; and
an indicator search space.

Advantageously, the method furthermore comprises the following steps:
d) analysis of the data table obtained at a preceding initial or supplementary extraction step in order to determine relevant indicators and/or relevant instances with respect to the initial specification of the study;
e) modification of said extraction dictionary as a function of the relevant indicators and/or the relevant instances; and
f) supplementary extraction of a new data table, in applying the modified extraction dictionary to said database.

Advantageously, a cycle comprising the steps d), e) and f) is performed at least twice.

According to an advantageous characteristic, said database is a data mart, and said method furthermore comprises a preliminary step for feeding said database from a data warehouse, said feeding step enabling the extraction and conversion of the data from the data warehouse in order to make the data correspond to a data model of said data mart.

Advantageously, said data model of the data mart is a data model provided with a main table connected in a multiple link with the fact tables.

Other data models can also be envisaged. The structure of the dictionaries will be adapted to the type of data model.

In another aspect of the disclosure, it is proposed a computer program product downloadable from a communications network and/or recorded on a computer-readable medium and/or executable by a processor, this computer program product comprising program code instructions for the execution of steps of the above-mentioned extraction method, when said program is executed on a computer.

In another aspect of the disclosure, it is proposed a system for the extraction of a data table from a database, said data table comprising instances in rows and columns respectively and comprising indicators characterizing said instances in columns and rows respectively, the system comprising:

means of obtaining an initial specification of a study;

means for building, from said initial specification, a data table extraction dictionary enabling the following:
specifying instances concerned by the study in the database;
specifying an extraction formula, a recoding and a role for each of the indicators concerned by the study; and
means of extraction of a data table, in applying said extraction dictionary to said database.

More generally, the data table extraction system according to an aspect of the disclosure comprises means of implementing the extraction method as described here above in any of its different embodiments.

Advantageously, the system furthermore comprises means of analysis of a data table obtained beforehand by the extraction means, in order to determine relevant indicators and/or relevant instances with respect to the initial specification of the study; and means of modification of said extraction dictionary as a function of the relevant indicators and/or the relevant instances. Said extraction means are again activated after said extraction dictionary has been modified, in order that said extraction means will extract a new data table, in applying the modified extraction dictionary to said database.

Advantageously, said database is a data mart, and said system furthermore comprises means for feeding said database from a data warehouse, said feeding means enabling the extraction and conversion of the data from the data warehouse so as to make this data correspond to a model of data of said data mart.

Other features and advantages of one or more aspect of the disclosure shall appear from the following description of an illustrative example, given by way of a non-restrictive indication (the various embodiments of the disclosure and claims, in their totality, are not limited to the characteristics and advantages of this illustrative example) and from the appended drawings.

### 4. BRIEF DESCRIPTION OF THE DRAWINGS

FIG. 1 shows the architecture of a classic decisional information system;

FIG. 2 is a drawing illustrating the general principle of the extraction technique according to a particular aspect of the disclosure;

FIG. 3 is a block diagram of a particular embodiment of the extraction system according to an aspect of the disclosure;

FIG. 4 is an example of a data model for the data mart appearing in FIG. 3;

FIG. 5 is a flow chart of a particular example of the method of extraction according to an aspect of the disclosure; and

FIG. 6 presents a structure of an extraction system according to a particular aspect of the disclosure.

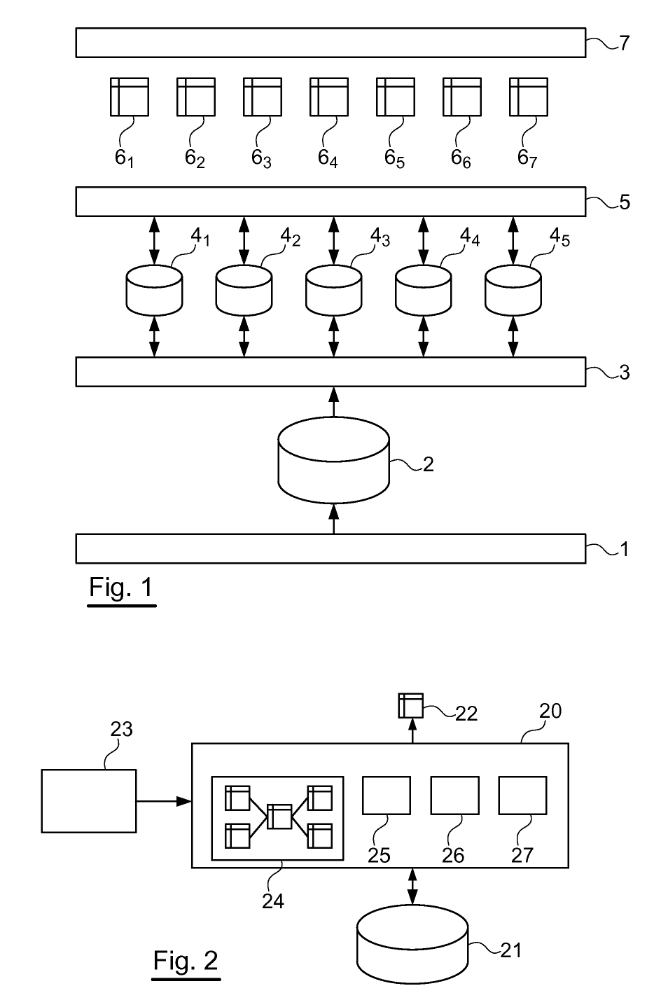

### 5. DETAILED DESCRIPTION

In all the figures of the present document, the identical elements or steps are designated by a same numerical reference.

5.1 Introduction

As illustrated in FIG. 2, one particular aspect of the disclosure pertains to an extraction system 20 used for the extraction of a data table 22 of a data warehouse 21 for a given study. This system 20 implements a driving method enabling the extraction process to be automated.

At input of the system 20, the user provides an initial specification of the study 23, comprising:
a target variable of the study, for example appetence for a product, or else no target variable;
the population concerned by the study, for example customers having seniority of less than five years; and
an initial query corresponding to the indicator search space.

At output, the system 20 automatically produces the data table 22 containing only the indicators and the instances relevant for the study. If no target variable has been specified, the system automatically produces the data table containing the search space indicators and the population concerned by the study.

The automation of the system relies on the driving of the information exchanges between the source data and the data selection process.

In the particular embodiment described in detail here below, the driving of the data extraction by a program is made possible by the coupling between a data mart 24 provided with a standardized data model and three fixed-format dictionaries 25 to 27.

This data mart 24 may be called a data folder. It serves as an interface between the data source 21 and the system 20. The data source 21 has a format or data model of any unspecified kind. The data mart 24 enables this data source to be standardized.

The dictionaries 25 to 27 have a fixed format corresponding to the data model of the data mart 24. The purpose of this fixed format is to standardize the specification of an extraction of a data table. This specification is subdivided into the following three dictionaries:
a data folder selection (or instances selection) dictionary 25 for choosing a population of study;
a queries or data folder queries dictionary 26 for specifying the queries produced on the data mart; and
a preparation or data table preparation dictionary 27 for specifying the recoding and the role of the indicators.

This subdivision of a query into three dictionaries enables the extraction of all the indicators necessary for the studies. The only limitation is that the system cannot be used to take account of the combinations of indicators to make for example a ratio. However, this combination can be done on the data table after the automatic extraction process.

The three dictionaries 25 to 27 mentioned here above together form a DTE (data table extraction) dictionary. In one variant, these three dictionaries 25 to 27 could be replaced by a single dictionary fulfilling all the necessary functions.

Similarly, the data folder queries dictionary 26 and the data table preparation dictionary 37 together form a DFIC (data folder indicators calculation) dictionary. In one variant, these two dictionaries 26 and 27 could be replaced by a single dictionary fulfilling all the necessary functions.

5.2 The System and Method of Automatic Extraction

5.2.1 General Description

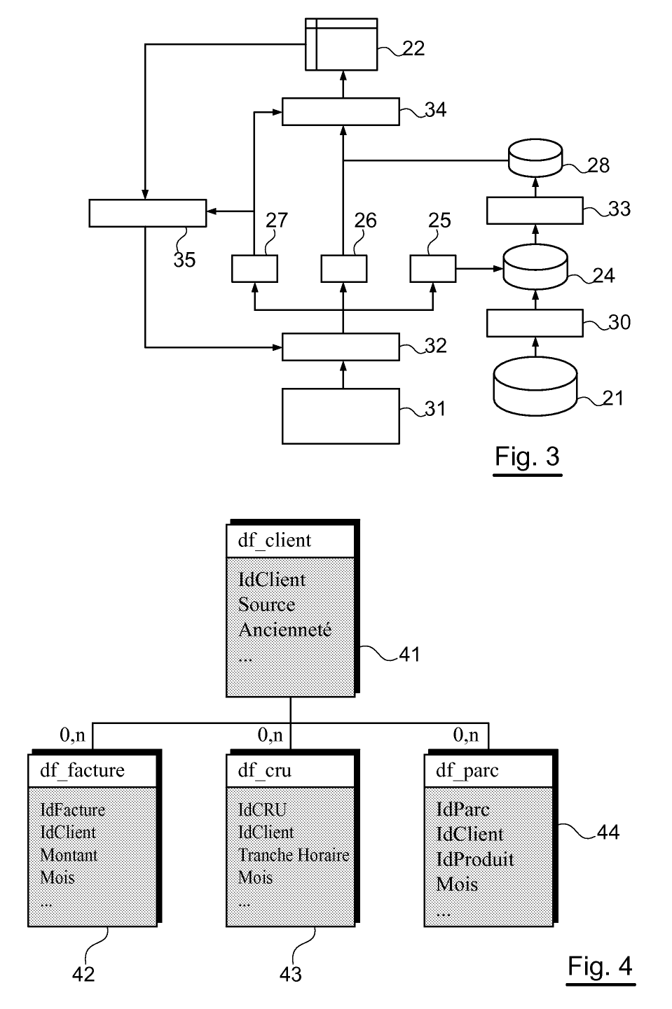

As illustrated in the block diagram of FIG. 3, in one particular example, the extraction system comprises:
a feeding module 30 for feeding the data mart 24 from the data warehouse 21;
a specification module 31 enabling the system to obtain an initial specification of the study. For example, the user (an analyst or any other person) provides this initial specification through a graphic user interface;
a driving module 22 enabling the three dictionaries to be built or modified. At the outset, the three dictionaries are built on the basis of the initial specification obtained by the specification module 31. Then, the three dictionaries are modified on the basis of relevant indicators and/or relevant instances given by the data selection module 35 (see below);
a filtering module 33 enabling the data mart 24 to be filtered by applying the data folder selection dictionary 25 and thus obtaining a filtered data mart 28;
an extraction (or breakdown and analysis) module 34 for extracting the data table 22 from the filtered data mart 28, by application of the data queries dictionary 26 and the data table preparation dictionary 27; and
a data selection module 35 enabling the analysis of a data table preliminarily extracted by the breakdown and analysis module 34 and enabling the driving modules as to be provided with the relevant indicators and/or relevant instances.

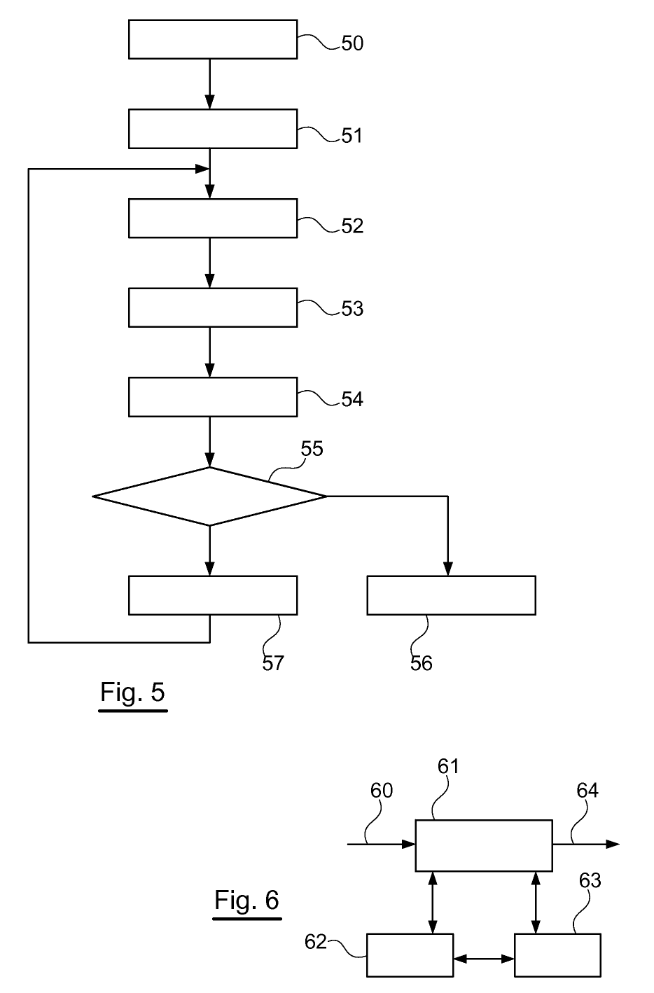

FIG. 6 presents a structure of the system of extraction according to a particular example. It comprises a memory 63, a processing unit 61 equipped for example with a microprocessor and driven by a computer program 62 implementing:
the above-mentioned modules (feed module 30, specification module 31, driving module 32, filtering module 33, extraction module 34 and data selection module 35) and
the method of extraction of a data table according to an aspect of the disclosure (for example the particular example described here below with reference to FIG. 5).

At reset, the instructions of the computer program 62 are for example loaded into a RAM and then executed by the processor of the processing unit 61.

Referring now to the flow chart of FIG. 5, a particular example is presented of the method of extraction according to the disclosure.

In a step referenced 50, the feeding module 30 feeds the data mart 24 from the data warehouse 21. In a step referenced 51, the specification module 31 obtains an initial specification of a study. In a step referenced 52, the driving module 32 builds the three dictionaries 25 to 27 from the above-mentioned initial specification. In a step referenced 53, the filtering module 33 obtains the filtered data mart 28 in filtering the data mart 24 by applying the data folder selection dictionary 25. In a step referenced 54, the extraction module 34 extracts the data table 22 from the filtered data mart 28 in applying the query dictionary 26 and the preparation dictionary 27. In a step reference 55, the system performs a detection to see whether a stop criterion is verified. In the event of positive detection, the operation passes to the end step referenced 56.

If not, a cycle comprising the successive steps referenced 57, 52, 53, 54 and 55 is performed. In the step referenced 57, the data selection module 25 analyses the data table and give the driving module 32 relevant indicators and/or relevant instances. In the step referenced 52, the driving module 32 modifies (if necessary) the three dictionaries 25 to 27 on the basis of the relevant indicators and/or relevant instances provided by the data selection module 35. In the step referenced 53, the filtering module 33 obtains a new filtered data mart 28 in filtering the data mart 24 by application of the modified data folder selection dictionary 25. In the step referenced 54, the breakdown and analysis module 24 extracts a new data table 22 from the new filtered data mart 28, in applying the data table queries dictionary 26 and the modified data table preparation dictionary 27. In the step referenced 55, the system again performs a detection to see whether the stop criterion is verified.

Thus, the automatic extraction process can be subdivided into at least two cycles:
a first cycle, comprising the steps referenced 50, 51, 52, 53, 54 and 55, whose goal is to produce a first data table containing all the indicators to be tested;
a second cycle, iterated at least once and comprising the steps referenced 57, 52, 53, 54 and 55, enabling the extraction specification coming from the data selection module to be taken into account.

It may be apt to reiterate the second cycle several times, so that, for example, the data selection module 35 first of all determines the relevant indicators and then the relevant instances that are representative in the sense of the indicators. In this case, the stop criterion is modified in order to execute the desired number of cycles.

5.2.2 Data Feed

The extraction system of the example is connected to the data source (data warehouse) 21 through a database, the data mart 24. The data mart is fed from the source database. The feeding process is aimed at extracting and converting the data of the data source in order to make it correspond to the data model of the data mart. This step 50 corresponds to the parametrizing of the system. It is done once and for all at the installation of the automatic extraction system above the data source.

The feed module 30 is obtained by means of an ETL (Extraction Transformation and Loading) type software program. The Amadea (registered mark) software program of the firm ISOFT is chosen, for example, to make this module, because of its performance in terms of volumetry and its simplicity of use.

5.2.3 Driving

The driving 52 includes writing and then modifying the dictionary containing the queries 26, the dictionary specifying the recoding and the role of each indicator 27 and the dictionary selecting the population 25.

These dictionaries can be modified, in the driving module 32, through the graphic user interface when it is the analyst who drives the extraction or for the initial specification phase. When the indicator and/or instances selection module 35 drives the extraction operations, the dictionaries are modified automatically to take account of the data selections.

The dictionaries are stored in the form of Excel tables. A program in C++ is used to interface the dictionaries with the output of the data selection module.

5.2.4 Filtering

The filtering 53 of the data mart enables the operation to be focused only on the population concerned by the study. This filtering is specified in the data folder selection (DFS) dictionary. The result of this operation is the filtered data mart.

The filtering module 33 is obtained by means of an ETL (Extraction Transformation and Loading) type software program. The Amadea (registered mark) software program of the firm ISOFT is chosen, for example, to make this module, because of its performance in terms of volumetry and its simplicity of use.

5.2.5 Breakdown and Analysis

The breakdown and analysis or extraction step 54 includes the application of the query dictionary or DFQ (Data Folder Queries) dictionary and the preparation or DTP (data table preparation) dictionary 27 to produce a data table 22 from the filtered data mart 28.

The extraction module 34 is obtained by means of an ETL type software program. The Amadea (registered mark) software program of the firm ISOFT is chosen, for example, to make this module, because of its performance in terms of volumetry and its simplicity of use.

5.2.6 Data Selection

The data selection module 35 analyses the data table 22 to determine the relevant indicators and the relevant instances (step 54). The relevance can be defined as a function of a target variable (i.e. a target indicator). The target variable is specified in the recoding dictionary 27. The list of indicators and instances chosen is given to the driving module 32.

The data selection module is made by the Khiops software program by the firm France Telecom described especially in the document FR2865056.

5.3 The Interfaces

5.3.1 The Data Mart

The purpose of the data mart 24 is to provide an interface between the source data 21 and the system 20. The data mart is a database with a standardized data model. The use of this type of data model illustrated in FIG. 4, enables the data source to be standardized:
the main table 41 corresponds to the domain under study. For the analysis of customer data, this table will include the information directly related to the customer such as his name, address etc.
   the fact table 42 to 44 has multiple links with the main table 41. Each instance of the main table has a variable number of facts corresponding to it. For telecommunications data, there will be for example a table describing the services possessed, a table charting the uses of these services, a table recapitulating the invoices etc.

This type of modeling is expressive enough to adapt to all types of data. The star pattern optimizes the computation of the indicators when the aggregation key keys are on the main table. In this case, the computation of an indicator necessitates at most a single joining between the main table and the fact table. In a data warehouse, the computation of an indicator may imply a very large number of joinings.

Finally, this type of data model, in which the role of each table is well defined, enables the building of formatted, hence automatable interrogation languages. Indeed, a query will always pertain to two tables at most: the main table and one of the fact tables. The aggregation key keys will always be on the main table. The aggregation formula will always pertain to the data of the fact table.

5.3.2 The Data Folder Selection (DFS) Dictionary

The data folder selection (DFS) dictionary 25 is used to specify the instances concerned by the study in the data mart 24. The selection relates to an aggregation key of the main table. This key is specified in the data table preparation (DTP) dictionary 27.

The data folder selection (DFS) dictionary 25 takes the form of a data table (see the example of table 2 here below). Each row is a condition possessing, for example, four columns enabling it to be defined. The table 1 here below presents an example of a language of the data folder selection dictionary. The use of this type of formatted dictionary enables a program to modify the selection. It is enough to modify the content of a box of the table to modify the selection.

TABLE 1

| .Keyword | Description |
|---|---|
| Table | Table covered by the query |
| ID | Identifier of the selection field |
| Val_Sel | Selected values: |
| | *: all the values |
| | {val1, . . . , valn}: list of values |
| | [val1, valn]: interval of values |
| | [val1, vali]; [valj, valn]: list of intervals of values |
| Action | Include or Exclude |

Each row of the data of folder selection (DFS) dictionary 25 is linked to the previous one by a logic AND operator. Since each condition may correspond to an inclusion or to an exclusion, this language enables two types of combinations between the conditions: the AND and the NAND operators. It can be demonstrated that with these two elementary logic operators, it is possible to build any other logic operator. The power of expression of this language is therefore sufficient to produce any selection of population on the data mart.

The example of table 2 here below enables the selection of the customers who have seniority of 1 to 5 years and possess the ADSL offer.

TABLE 2

| Table | ID | Val_Sel | Action |
|---|---|---|---|
| df_tiers | seniority | [1; 5] | Include |
| df_edp | Offer | ADSL | Include |

5.3.3 The Data Folder Query (DFQ) Dictionary

The data folder query (DFQ) dictionary 26 is used to specify the breakdown and analysis of the data of the data mart from a set of queries. Each query relates to an aggregation key of the main table. This key is specified in the data table preparation (DTP) dictionary 27.

The data folder queries dictionary (DFQ) 26 takes the form of a data table. Each row is a query having m columns. The table 3 here below presents an example of a language of the data folder queries dictionary. The use of this type of formatted dictionary enables a program to modify a query. It is enough to modify the content of one box of the table to modify the query.

TABLE 3

| Keyword | Description |
|---|---|
| ID | Identifier of the family of indicators |
| Type | Type of the family of indicators (Symbol, Continuous) |
| Table | Table covered by the query |
| Operator | Get: Retrieve the data |
| | InstanceNumber: Number of instances of the operand |
| | field |
| | ValueNumber: Number of different values of the |
| | operand field |
| | Total: Sum of the values of the operand field |
| | MeanValue: Mean value of the operand field |
| | . . . |
| Operand | Main field covered by the operator |
| ID_Sel_1 to m | Identifier of cross field with which operand will be |
| | crossed |
| OP_Sel_1 to m | Cross field, i.e. field of the source table covered by |
| | the crossing |
| Val_Sel_1 to m | Selected values: |
| | *: all the values |
| | {val1, . . . , valn}: list of values |
| | [val1, valn]: interval of values |
| | [val1, vali]; [valj, valn]: list of interval of values |

Each of the rows of the data folder queries (DFQ) dictionary 26 corresponds to an elementary query that generates an elementary data table containing a number of instances (fixed whatever the elementary query: it is the number of instances of the filtered data mart 28) and a number of indicators (variable as a function of the elementary query). Each row is independent of the others. The resulting data table is concatenated by column of the different elementary data tables.

This language is powerful enough to enable the specifying of a large number of indicators in a few rows. Table 4 here below is an example of specifications of five families of indicators:
civil status: one indicator;
customers' identifier: one indicator;
tally of different numbers called per time slot and per month: 288 indicators (24 hours*12 months);
the number of total calls per month: 12 indicators (12 months); and

the duration of calls per day named and month: 84 indicators (7 days*12 months).

TABLE 4

| ID | Type | table | operator | operand | ID_Sel_1 | OP_Sel_1 | Val_Sel_1 |
|---|---|---|---|---|---|---|---|
| civil status | Symbol | df_tiers | Get | Civil status | | | |
| Idclient | Continuous | df_tiers | Get | age | | | |
| nb_num_diff_appele | Continuous | df_cru | ValueNumber | ND_appele_crypte | _TH | tranche_horaire | * |
| nb_appels_total | Continuous | df_cru | InstanceNumber | ND_appele_crypte | _M | _mois | * |
| du_appels | Continuous | df_cru | Total | duree | _J | jour_nomme | * |

| ID | ID_Sel_2 | OP_Sel_2 | Val_Sel_2 | Generated indicator name |
|---|---|---|---|---|
| civil status | | | | Civil status |
| Idclient | | | | Age |
| nb_num_diff_appele | _M | mois | * | nb_num_diff_appele_TH1_M1; . . . |
| | | | | nb_num_diff_appele_TH24_M1; . . . |
| | | | | nb_num_diff_appele_TH24_M6 |
| nb_appels_total | | | | nb_appels_total_M1; . . . |
| | | | | nb_appels_total_M6 |
| du_appels | _M | mois | * | du_appels_Jlundi_M1; . . . |
| | | | | du_appels_Jdimanche_M1; . . . |
| | | | | du_appels_Jdimanche_M6 |

5.3.4 The Data Table Preparation (DTP) Dictionary

The data table preparation (DTP) dictionary 27 is consistent with the data folder queries (DFQ) dictionary 26. It is generated for example from this dictionary, in order to specify the recoding and the role of each of the indicators produced by the queries of the data folder queries dictionary. The data table preparation (DTP) dictionary 27 takes the form of a data table. Each row corresponds to an indicator and each of the six columns corresponds to one characteristic of the indicator. Table 5 here below is an example of a language of the data table preparation dictionary. The use of this type of formatted dictionary enables a program to modify the recoding. It is enough to modify the content of a box of the table to modify the recoding.

TABLE 5

| Keyword | Description |
|---|---|
| Name | Name of the indicator |
| Label | Long label of the indicator. This label is generated by the |
| | interpretation of the DFQ query |
| Type | Type of the family of indicators (Symbol, Continuous) |
| Status | “T” for the target indicator (target) |
| | “I” for the indicator identifying the aggregation |
| | “V” for the explanatory indicators |
| | “U” for the unused indicators |
| F_extract | Formula for computation from data mart. This extraction |
| | formula is taken up from the folder queries (DFQ) |
| | in separating the fields by “/” |
| F_discret | Discretisation formula (grouping formula if symbolic |
| | indicator) |
| | For the continuous indicators, list of intervals [a, b] would |
| | be used or lists of values separated by “;” to |
| | specify the breaks. |
| | For the modal indicators, list of groups of values {a, b} would |
| | be used or a list of values separated by “;” to |
| | specify the breaks. |
| Level | Evaluation of the predictive value of the indicator. This |
| | predictive value may be given by an indicator |
| | selection algorithm. |

TABLE 6

| Name | Label | Type | Status | F_Extract | F_discret | Level |
|---|---|---|---|---|---|---|
| V1 | Civil status | Symbol | T | df_tiers/Get/civil status | M; | |
| | | | | | {Mme, | |
| | | | | | Mlle} | |
| V2 | Age | Symbol | V | df_tiers/Get/age | | |
| V3 | nb_num_diff_appele_TH1_M1 | Continuous | V | df_cru/valueNumber/ND_appele/_TH/tranche_horaire/ | | |
| . . . | . . . | | | 1/_M/mois/1 | | |
| V146 | nb_num_diff_appele_TH24_M6 | | | . . . | | |
| | | | | df_cru/ValueNumber/ND_appele/_TH/tranche_horaire/ | | |
| | | | | 24/_M/mois/6 | | |
| V147 | nb_appels_total_M1 | Continuous | V | df_cru/InstanceNumber/_M/mois/1 | 10 | |
| . . . | . . . | | | . . . | . . . | |
| V153 | nb_appels_total_M6 | | | df_cru/InstanceNumber/_M/mois/6 | 10 | |
| | | | | | [0,10 | |
| | | | | | [;[10; | |
| | | | | | 20] | |
| | | | | | . . . | |
| V154 | du_appels_Jlundi_M1 | | | df_cru/Total/duree_J/jour_nomme/1/_M/mois/1 | [0,10 | |
| . . . | . . . | | | . . . | [;[10; | |
| V196 | du_appels_Jdimanche_M6 | Continuous | V | df_cru/Total/duree_J/jour_nomme/1/_M/mois/1 | 20] | |

Although the present disclosure has been described with reference to one or more illustrative examples, workers skilled in the art will recognize that changes may be made in form and detail without departing from the spirit and scope of the disclosure and/or the appended claims.

What is claimed is:

1. A method for the extraction of a data table from a database, said data table comprising instances in rows and columns respectively and comprising indicators characterizing said instances in columns and rows respectively, said method comprising the following steps:
a) obtaining an initial specification of a study;
b) from said initial specification, building a data table extraction dictionary enabling the following:
specifying instances concerned by the study in the database; and
specifying an extraction formula, a recoding and a role for each of the indicators concerned by the study; and
c) carrying out an initial extraction of a data table, in applying said extraction dictionary to said database.

2. A method according to claim 1, wherein said data table extraction dictionary comprises:
a data folder selection dictionary to specify the instances concerned by the study in the database; and
a data folder indicators calculation dictionary to specify the formula of extraction, the recoding and the role of each of the indicators.

3. A method according to claim 2, wherein said extraction of the data table comprises the following steps:
application of said data folder selection dictionary to said database, in order to pertain a filtered database; and
application of said data folder indicators calculation dictionary to said filtered database in order to obtain said data table.

4. A method according to claim 3, wherein said data folder selection dictionary takes the form of a data table comprising conditions in rows and columns respectively and characteristics characterizing said conditions in columns and rows respectively, wherein each condition may correspond to an inclusion or an exclusion, and wherein each row of the data folder selection dictionary is linked to the previous one by a logic AND operator.

5. A method according to claim 2, wherein said data folder indicators calculation dictionary comprises:
a data folder query dictionary used to specify the formula of extraction of each of the indicators; and
a data table preparation dictionary used to specify the recoding and the role of each of the indicators.

6. A method according to claim 5, wherein said data folder query dictionary takes the form of a data table comprising elementary queries in rows and columns respectively and comprising characteristics characterizing said elementary queries in columns and rows respectively and wherein at each initial or supplementary step of extraction of a data table:
each elementary query enables the extraction from said database of an elementary data table; and
the elementary data tables are concatenated by columns and rows respectively in order to obtain said data table.

7. A method according to claim 5, wherein said data table preparation dictionary takes the form of a data table comprising said indicators in rows and columns respectively and characteristics characterizing said elementary indicators in columns and rows respectively.

8. A method according to claim 1, wherein the initial specification of the study specifies:
no target indicator or a target indicator;
a population concerned; and
an indicator search space.

9. A method according to claim 1, furthermore comprising the following steps:
d) analysis of the data table obtained at a preceding initial or supplementary extraction step in order to determine relevant indicators and/or relevant instances with respect to the initial specification of the study;
e) modification of said extraction dictionary as a function of the relevant indicators and/or the relevant instances; and
f) supplementary extraction of a new data table, in applying the modified extraction dictionary to said database.

10. A method according to claim 9, wherein a cycle comprising the steps d), e) and f) is performed at least twice.

11. A method according to claim 1, wherein said database comprises a data mart, and wherein said method furthermore comprises a preliminary step of feeding said database from a data warehouse, said feeding step enabling the extraction and conversion of the data from the data warehouse in order to make the data correspond to a data model of said data mart.

12. A method according to claim 11, wherein said data model of the data mart comprises a data model provided with a main table connected in a multiple link with fact tables.

13. A computer program product recorded on a computer-readable medium, this computer program product comprising program code instructions, which perform the following steps to extract a data table from a database, said data table comprising instances in rows and columns respectively and comprising indicators characterizing said instances in columns and rows respectively, when said instructions are executed on a computer:
a) obtaining an initial specification of a study;
b) from said initial specification, building a data table extraction dictionary enabling the following:
specifying instances concerned by the study in the database; and
specifying an extraction formula, a recoding and a role for each of the indicators concerned by the study; and
c) carrying out an initial extraction of a data table, in applying said extraction dictionary to said database.

14. A system for the extraction of a data table from a database, said data table comprising instances in rows and columns respectively and comprising indicators characterizing said instances in columns and rows respectively, the system comprising:
a specification module, which obtains an initial specification of a study;
a driving module, which builds, from said initial specification, a data table extraction dictionary enabling the following:
specifying instances concerned by the study in the database;
specifying an extraction formula, a recoding and a role for each of the indicators concerned by the study; and
an extraction module, which extracts a data table, in applying said extraction dictionary to said database.

15. A system according to claim 14, furthermore comprising:
a data selection module, which enables analysis of a data table obtained beforehand by the extraction module, in order to determine relevant indicators and/or relevant instances with respect to the initial specification of the study;
said driving module further enabling modification of said extraction dictionary as a function of the relevant indicators and/or the relevant instances,
said extraction module being again activated after said extraction dictionary has been modified, in order that said extraction module will extract a new data table, in applying the modified extraction dictionary to said database.

16. System according to claim 14, wherein said database comprises a data mart, and said system furthermore comprises a feeding module, which feeds said database from a data warehouse, said feeding module enabling the extraction and conversion of the data from the data warehouse so as to make this data correspond to a model of data of said data mart.
